(19) United States
(12) Patent Application Publication
(10) Pub. No.: US 2025/0214065 A1
(43) Pub. Date: Jul. 3, 2025

(54) CATALYST FOR HYDROCARBON FUEL EMISSION AND FUEL USAGE REDUCTION

(71) Applicant: John Dale Stansell, Gainesville, TX (US)

(72) Inventor: John Dale Stansell, Gainesville, TX (US)

(73) Assignee: JAKE VERNON LLC, Gainesville, TX (US)

(21) Appl. No.: 18/936,407

(22) Filed: Nov. 4, 2024

Related U.S. Application Data
(60) Provisional application No. 63/615,025, filed on Dec. 27, 2023.

(51) Int. Cl. B01J 27/10; B01J 23/04; B01J 23/36; B01J 27/125; B01J 27/13; B01J 31/02; B01J 31/32; B01J 35/27; B01J 35/31; C10L 1/12; F02B 47/06

(52) U.S. Cl. CPC B01J 27/10; B01J 23/04; B01J 23/36; B01J 27/125; B01J 27/13; B01J 31/0202; B01J 31/32; B01J 35/27; B01J 35/31; C10L 1/1225; F02B 47/06; B01J 2531/985; C10L 2230/22; C10L 2300/20

(57) ABSTRACT

A catalyst for improving emissions and fuel efficiency in combustion chambers may include aluminum chloride, cerium (III) chloride, deionized water, propylene glycol, lithium chloride, chloroplatinic acid, rhodium chloride, perrhenic acid, and a pH adjuster, such as lithium hydroxide or hydrochloric acid reagent. A method of improving emissions and fuel efficiency in combustion chambers while simultaneously enhancing combustion of hydrocarbons may include introducing the catalyst via a vaporous transport into the flame zone of a combustion chamber.

### RELATED APPLICATION

This application claims priority to provisional patent application U.S. Ser. No. 63/615,025 filed on Dec. 27, 2023, the entire contents of which is herein incorporated by reference.

### BACKGROUND

The embodiments herein relate generally to fuel efficiency, and more particularly, to a method and catalyst for improving emissions and fuel efficiency in combustion chambers.

Fuel consumption efficiency is generally considered to be subpar in combustion chambers. There is much room for the improvement of efficiency in fuel consumption combustion chambers. Specifically, it is surmised that if fuel propagation is accelerated during the combustion of hydrocarbon fuels, then the efficiency in combustion chambers could be improved. If the efficiency could be improved, fuel usage could be reduced.

Conventional catalysts for increasing fuel efficiency lack key components that accelerate fuel propagation. More specifically, the missing components prevent consistent bonding of the catalyst on the fuel mixture, thereby not providing sufficient, improved results.

Therefore, what is needed is a method and composition for improving emissions and fuel efficiency in combustion chambers.

### SUMMARY

Some embodiments of the present disclosure include a catalyst for improving emissions and fuel efficiency in combustion chambers. The catalyst may include aluminum chloride, cerium (III) chloride, deionized water, propylene glycol, lithium chloride, chloroplatinic acid, rhodium chloride, perrhenic acid, and a pH adjuster, such as lithium hydroxide or hydrochloric acid reagent. A method of improving emissions and fuel efficiency in combustion chambers while simultaneously enhancing combustion of hydrocarbons may include introducing the catalyst via a vaporous transport into the flame zone of a combustion chamber.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

The method and composition of the present disclosure may be used to improve emissions and fuel efficiency in combustion chambers and may comprise the following elements. This list of possible constituent elements is intended to be exemplary only, and it is not intended that this list be used to limit the method and composition of the present application to just these elements. Persons having ordinary skill in the art relevant to the present disclosure may understand there to be equivalent elements that may be substituted within the present disclosure without changing the essential function or operation of the method and composition.

The various elements of the present disclosure may be related in the following exemplary fashion. It is not intended to limit the scope or nature of the relationships between the various elements, and the following examples are presented as illustrative examples only.

By way of example, some embodiments of the present disclosure include a method and composition for improving emissions and fuel efficiency in combustion chambers, the method comprising introducing a catalyst into a flame zone of a combustion chamber, such that the catalyst is held by gases in the flame zone prior to and during combustion of the fuel, thereby ionizing the catalyst prior to or during the combustion. The ionized catalyst may aid in more complete ignition and burning of present hydrocarbon fuels. The method may improve the efficiency in combustion chambers, oxidize carbon build up in the cylinder, and enhance fuel propagation during the combustion of the hydrocarbon fuels. In other words, use of the method and composition of the present disclosure may accelerate the fuel propagation during combustion of the hydrocarbon fuels.

The composition of the present disclosure may form a catalyst, wherein the composition may comprise aluminum chloride and cerium (III) chloride, as main ingredients. More specifically, the composition may comprise deionized water, propylene glycol, lithium chloride, chloroplatinic acid, rhodium chloride, perrhenic acid, cerium (III) chloride, aluminum chloride, and a pH adjuster, such as lithium hydroxide or hydrochloric acid reagent.

In a particular embodiment, the composition may comprise about 70 to about 75 wt. %, such as about 71.8 wt. %, deionized water; about 25 to about 30 wt. %, such as about 27.6 wt. %, propylene glycol; about 0.1 to about 0.5 wt. %, such as about 0.39 wt. %, lithium chloride; about 0.05 to about 0.2 wt. %, such as about 0.11 wt. %, chloroplatinic acid; about 0.01 to about 0.02 wt. %, such as about 0.013 wt. %, rhodium chloride; about 0.01 to about 0.02 wt. %, such as about 0.018 wt. %, perrhenic acid; about 0.05 to about 0.1 wt. %, such as about 0.098 wt. %, cerium (III) chloride; about 0.005 to about 0.01 wt. %, such as about 0.0098 wt. % aluminum chloride, and a pH adjuster, such as lithium hydroxide or hydrochloric acid reagent.

To make the composition of the present disclosure, deionized water and propylene glycol may be first mixed together for a period of, for example, about 10 minutes. Lithium chloride may be added to the mixture and dissolved, and the pH may be adjusted to from about 3.3 to about 3.7. Chloroplatinic acid may then be added and the solution may be mixed well, again maintaining the pH at about 3.3 to about 3.7. The rhodium chloride may then be added and the solution may be mixed, still maintaining the pH at about 3.3 to about 3.7. Perrhenic acid may be added next and the solution may be mixed, again while maintaining the pH at about 3.3 to about 3.7. The pH of the final solution may then be adjusted to 2.9 to 3.1 by adding lithium hydroxide or hydrochloric acid reagent to raise or lower the pH, respectively. To create the desired solution, the ingredients should be mixed in the above order. The resulting solution may be a clear, orange colored liquid with a specific gravity of 1.12, a density of 9.34 lbs./gal, and a pH of 2.9-3.1.

A method of improving emissions and fuel efficiency in combustion chambers while simultaneously enhancing combustion of hydrocarbon fuels may comprise introducing a mixture of a composition comprising vaporous metallic compounds via a vaporous transport into the flame zone of a combustion chamber substantially homogeneously, such that the mixture is held by gases in the flame zone before and during the combustion of the fuel, and the mixture is thereby ionized prior to or during the combustion, and the ionized mixture of compounds contains about 10-30 parts per million of measure of fuel. In embodiments, the mixture of compounds may be introduced into the combustion chamber through an air flow few into the combustion chamber. Alternatively, the mixture of compounds may be introduced into the combustion chamber through a mixture of fuel and air fed into the combustion chamber

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A catalyst for improving emissions and fuel efficiency in combustion chambers,
the catalyst comprising:
aluminum chloride; and
cerium (III) chloride.

2. The catalyst of claim 1, further comprising:
deionized water;
propylene glycol;
lithium chloride;
chloroplatinic acid;
rhodium chloride;
perrhenic acid; and
a pH adjuster.

3. The catalyst of claim 2, wherein the pH adjuster is a member selected from the group consisting of lithium hydroxide and hydrochloric acid reagent.

4. The catalyst of claim 2, wherein:
the catalyst is a liquid;
the catalyst has a specific gravity of about 1.12;
the catalyst has a density of about 9.34 lbs/gal; and
the catalyst has a pH of from about 2.9 to about 3.1.

5. The catalyst of claim 2, wherein the catalyst comprises:
about 70 to about 75 weight (wt.) % deionized water;
about 25 to about 30 wt. % propylene glycol;
about 0.1 to about 0.5 wt. % lithium chloride;
about 0.05 to about 0.2 wt. % chloroplatinic acid;
about 0.01 to about 0.02 wt. % rhodium chloride;
about 0.01 to about 0.02 wt. % perrhenic acid;
about 0.05 to about 0.1 wt. % cerium (III) chloride;
about 0.005 to about 0.01 wt. % aluminum chloride; and
the pH adjuster.

6. The catalyst of claim 5, wherein the catalyst comprises:
about 71.8 wt. % deionized water;
about 27.6 wt. % propylene glycol;
about 0.39 wt. % lithium chloride;
about 0.11 wt. % chloroplatinic acid;
about 0.013 wt. % rhodium chloride;
about 0.018 wt. % perrhenic acid;
about 0.098 wt. % cerium (III) chloride;
about 0.0098 wt. % aluminum chloride; and
the pH adjuster.

7. A method of improving emissions and fuel efficiency in a combustion chamber, the method comprising:
introducing a catalyst into the combustion chamber prior to combustion,
the catalyst comprising:
aluminum chloride; and
cerium (III) chloride.

8. The method of claim 6, wherein the catalyst further comprises:
deionized water;
propylene glycol;
lithium chloride;
chloroplatinic acid;
rhodium chloride;
perrhenic acid; and
a pH adjuster.

9. The method of claim 8, wherein the catalyst comprises:
about 70 to about 75 weight (wt.) % deionized water;
about 25 to about 30 wt. % propylene glycol;
about 0.1 to about 0.5 wt. % lithium chloride;
about 0.05 to about 0.2 wt. % chloroplatinic acid;
about 0.01 to about 0.02 wt. % rhodium chloride;
about 0.01 to about 0.02 wt. % perrhenic acid;
about 0.05 to about 0.1 wt. % cerium (III) chloride;
about 0.005 to about 0.01 wt. % aluminum chloride; and
the pH adjuster.

10. The method of claim 7, wherein the catalyst is introduced into a flame zone of the combustion chamber, such that the catalyst is held by gases in the flame zone prior to and during combustion of fuel.
